(19) United States
(12) Patent Application Publication
(10) Pub. No.: US 2005/0262096 A1
(43) Pub. Date: Nov. 24, 2005

(54) Server apparatus and information delivery method

(75) Inventor: Masatomo Okadome, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/121,088

(22) Filed: May 4, 2005

(30) Foreign Application Priority Data
May 10, 2004 (JP) 2004-139385

(51) Int. Cl. G06F 7/00

(52) U.S. Cl. 707/10

(57) ABSTRACT

This is an invention of improvement to a server apparatus that delivers information corresponding to a desired event through a network in accordance with a request from a terminal which is executing a client program. The apparatus includes the first connection device that establishes the first connection with the terminal using a first protocol at a predetermined entrance and delivers a program that is executed on the client program of the terminal and information to the terminal, and the second connection device that creates a new entrance when delivery of the information is requested via the first connection and establishes the second connection using the second protocol with the terminal at this new entrance and notifies the generation of the desired event. The first connection device notifies the terminal via the first connection, of the new entrance created by the second connection device.

### BACKGROUND OF THE INVENTION

1. Field of the Invention

The present invention relates to a Push type server apparatus and information delivery method that deliver information regarding a desired event through a network to a terminal on which a client program is activated. Specifically, it relates to a server apparatus and information delivery method that can deliver information in real time while rejecting unauthorized access.

Priority is claimed on Japanese Patent Application No. 2004-139385, filed May 10, 2004, the contents of which are incorporated herein by reference.

2. Description of Related Art

In recent years a measurement apparatus (for example, a waveform measurement apparatus) has often been connected to a network and has carried out communication with an external device (for example a personal computer). Then, the waveform measurement apparatus, as an information delivery device, delivers information (measurement data, image data, an alarm signal, and so forth), in accordance with a request from the personal computer (for instance, see Japanese Unexamined Patent Application, First Publication No. 2001-56896 (paragraph numbers 0002-0007, FIG. 7)). That is, the waveform measurement apparatus side is a web server, and the personal computer side becomes a web client. FIG. 3 is a diagram showing a conventional information delivery system. The measurement device carries out measurement, and the system by which the personal computer collects the results of the measurement is called a measurement system.

In FIG. 3, a network 100 is an intranet, the internet or the like, using for example, Ethernet (Registered Trademark) cable. A waveform measurement apparatus 10 is a server apparatus, having a waveform measurement portion 11 and a web server 12, and is connected to the network 100. The waveform measurement portion 11 has a waveform measurement device 11a, an acquisition memory 11b, a display portion 11c, a storage device 11d, and a CPU (Central Processing Unit) 11e, and measures a target signal to be measured, which is an input signal.

The waveform measurement device 11a converts the target signal to be measured into a digital signal that is measurement data, by means of an analog-to-digital converter (not shown in the figure), and stores it in the acquisition memory 11b. The display portion 11c displays the waveform of the measurement data stored in the acquisition memory 11b, and displays an analysis result of the measurement data and the like.

The storage device 11d is a memory portion, for example an integrated hard disk of the apparatus itself, floppy (Registered Trademark) disk, a flash ATA memory card with an interface that complies with IDE standards, or the like. Moreover, the storage device 11d stores the measurement data that the acquisition memory 11b stores, the picture image displayed by the display portion 11c, the program that is executed on the web client, and the like. The CPU 11e controls the whole of the waveform measurement portion 11.

The web server 12 converts the measurement data, picture image and the like of the waveform measurement portion 11 into an appropriate type of file (text file, picture image file, music or voice file, and the like), and transmits these files and a program of the storage device 11d, and so forth to a personal computer 20 through the network 100.

A web browser 21 is installed in the personal computer 20, and the web browser 21 is executed. Also, the personal computer 20 is connected to the network 100. The web browser 21 is a client program, which requests a desired file from the waveform measurement apparatus 10 and displays the file from the waveform measurement apparatus 10.

The operation of such an apparatus is described. First of all, the operation of the waveform measurement portion 11 is described. The waveform measurement device 11a of the waveform measurement portion 11 generates a trigger signal to measure a target signal to be measured whenever a target signal to be measured of the desired form is input, and the measurement data that has been measured is stored in the acquisition memory 11b. Moreover, the measurement data of the acquisition memory 11b and the image data displayed by the display portion 11c are stored in the storage device 11d by the CPU 11e. Also, data processing and analysis (calculation, measuring, and XY correlation analysis (analysis of the correlation of two input signals, with the voltage axis of the input signal of the specified channel for the X axis, and the voltage axis of the input signal of another channel for the Y axis.), and so forth.) of the measurement data, is carried out by the CPU 11e, and a waveform display of the measurement data and display of the analysis result, and so forth is carried out by the display portion 11c.

Next, the sending and receiving of files from the waveform measurement apparatus 10 and the personal computer 20 is described.

The web browser 21 of the personal computer 20 requests the transmission of a desired file (for instance, a picture image file) from the web server 12 of the waveform measurement apparatus 10. As a result, the web server 12 attaches an appropriate header to the requested picture image file, and transmits it to the web browser 21. A “file” may be a static file that is stored in the storage device 11d as well as a file that is dynamically generated from the acquisition memory 11b in a manner such as on-demand. Then the web browser 21 displays the received file.

In this way, the waveform measurement apparatus 10, which is the web server, begins processing (for instance, file generation and file transmission) only after there is a request from the personal computer 20, which is the web client. This kind of format in which communication is initiated by the side that is to receive information (the personal computer 20) is called a Pull type delivery system (for example see Japanese Unexamined Patent Application, First Publication No. 3142820-56896 (paragraph number 0002)).

However, since the personal computer 20 communicates regularly with the waveform measurement apparatus 10 in the apparatus shown in FIG. 3, the following problems exist in the case in which an event generated in the waveform measurement apparatus 10 (for example a trigger event) is to be monitored.

Since the waveform measurement apparatus 10 and the personal computer 20 communicate at regular intervals, there is the problem that time precision of event generation cannot be higher than that of the communication frequency, and real time performance is impaired. Also, there is a problem that there is more communication traffic compared with the method in which communication from the waveform measurement apparatus 10 is carried out only when an event is generated (so-called Push type delivery system (for example, see Japanese Unexamined Patent Application, First Publication No. 3142820-56896 (paragraph number 0002))). Of course, raising the communication frequency in order to increase time accuracy can be considered, however there is a problem that the communication traffic increases significantly.

### SUMMARY OF THE INVENTION

The first aspect of the invention is a server apparatus that delivers information corresponding to a desired event through a network in accordance with a request from a terminal executing a client program, comprising: first connection device that establishes first connection with said terminal applying first protocol at a predetermined entrance, and delivers a program that is executed on the client program of the terminal, and the information, to said terminal; and second connection device that creates a new entrance when delivery of the information is requested via the first connection, and establishes second connection applying second protocol with said terminal at the new entrance, and notifies generation of the desired event; and wherein the first connection device notifies the terminal via the first connection, of the new entrance created by the second connection device. The second aspect of the invention is a server apparatus which is described above, wherein said client program is a browser.

The third aspect of the invention is a server apparatus which is described above, wherein the first connection and the second connection communicate applying the communication protocol TCP/IP.

The fourth aspect of the invention is a server apparatus which is described above, wherein the first protocol is HTTP, and the second protocol is a protocol different from HTTP.

The fifth aspect of the invention is a server apparatus which is described above, wherein the server apparatus is a measurement device.

The sixth aspect of the invention is an information delivery method in which a server apparatus delivers information corresponding to a desired event through a network to a terminal that a client program is executed, comprising: a step in which said terminal connects to a predetermined entrance on the server applying first protocol, downloads a program that is executed on the client program and establishes first connection, and requests notification of creation of the desired event to said server apparatus; a step in which the server apparatus creates an event delivery entrance for notifying the creation of the desired event; a step in which the server apparatus notifies the terminal of the event delivery entrance which is created via first connection; a step in which the terminal connects to the event delivery entrance notified by the server apparatus via second protocol and establishes second connection; a step in which, when the event which is requested from the terminal is created, the server apparatus notifies the terminal of creation of the event via the second connection; a step in which the terminal, on being notified of the creation of the event from the server apparatus, requests delivery of information corresponding to the event to the server via the first connection; and a step in which the server apparatus delivers information corresponding to the event to the terminal via the first connection.

According to the present invention, there are following effects. According to the first to fifth aspects of the invention, when the delivery of information corresponding to the event is requested via the first connection from the terminal, the second connection device dynamically creates a new entrance, the second connection is established, and the occurrence of an event is notified to the terminal. As a result, the terminal can synchronize with the occurrence of the event and request delivery of information in real time. Therefore, information is updated in real time on the terminal side in synchrony with the event. Moreover, since the new entrance is first established only after the delivery of information corresponding to the event is requested from the terminal (in other words, it is not always open,) it is not likely to be subject to unauthorized access by a third party. Therefore, the server apparatus can carry out the delivery of information in real time and can control unauthorized access.

According to the fifth aspect, since the server apparatus is a measurement device, for example, in measuring the wavelength, even in the case in which the measurement data is acquired with a trigger, information (picture image) on the terminal side can be updated in real time in synchrony with the trigger. Moreover, since the second connection device notifies the occurrence of an event even if it is an event occurring irregularly, such as the trigger, communication traffic can be controlled.

According to the sixth aspect of the invention, the terminal connects to the entrance predetermined by the server apparatus via the first protocol, and requests from the server apparatus notification of the occurrence of the desired event. Then, the server apparatus creates an event delivery gateway for notifying the occurrence of the desired event. Furthermore, the terminal connects to the event delivery entrance using the second protocol, establishes the second connection, and carries out communication. As a result, the terminal can synchronize with the occurrence of the event and request delivery of information in real time. Therefore, information is updated in real time on the terminal side in synchrony with the event. Moreover, since the event delivery gateway is first established only after the delivery of information relating to the event is requested from the terminal (in other words, it is not always open,) it is not likely to be subject to unauthorized access by a third party. Therefore, the delivery of information in real time can be carried out, and unauthorized access can be rejected.

### BRIEF DESCRIPTION OF THE DRAWINGS

FIG. 1 is a block diagram showing an example of the present invention.

FIG. 2 is a sequence diagram showing the operation of the system shown in FIG. 1.

FIG. 3 is a diagram showing the construction of a conventional measurement system.

### DETAILED DESCRIPTION OF THE INVENTION

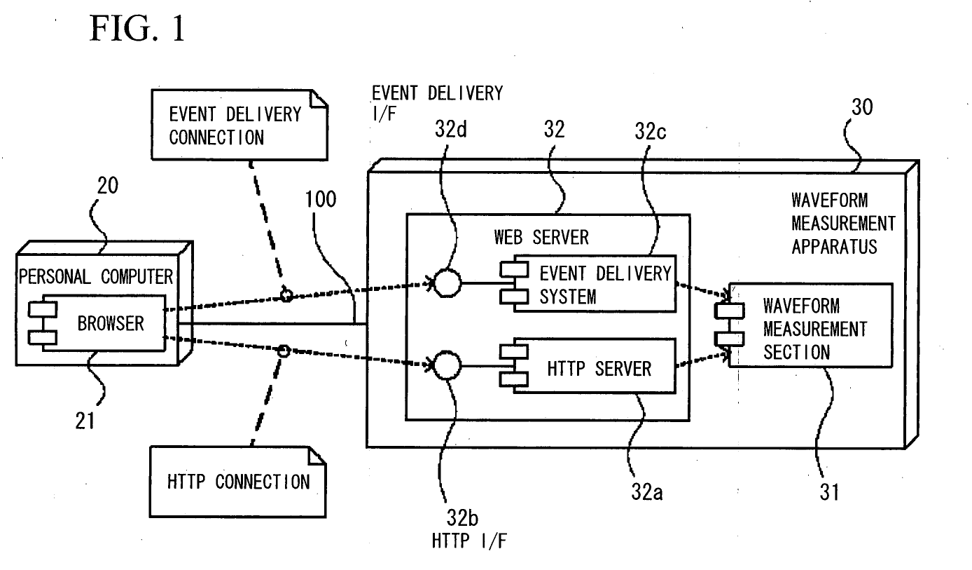

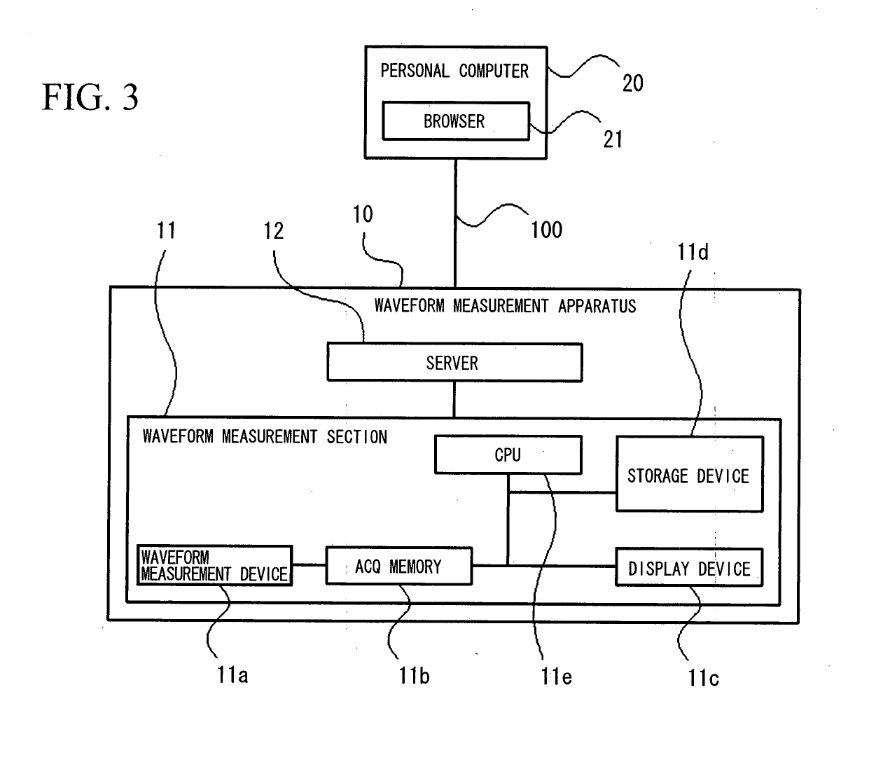

An implementation of the present invention is described below referring figures. FIG. 1 is a block diagram showing an example of the present invention. Here, the same reference symbols are affixed to items that are the same as in FIG. 3, and their descriptions are omitted. Moreover it is illustrated using UML (Unified Modeling Language) notation. In FIG. 1, a waveform measurement apparatus 30 is provided instead of the waveform measurement apparatus 10. The waveform measurement apparatus 30 is a server apparatus, connected to a network 100, and having a waveform measurement section 31 and a web server 32. Since the waveform measurement section 31 is similar to the waveform measurement portion 11 shown in FIG. 3, the description thereof is omitted, and illustration of the waveform measurement device, acquisition memory, display device, storage device, and CPU are also omitted.

The web server 32 has an HTTP (Hyper Text Transfer Protocol) server 32a, an HTTP interface 32b, an event delivery system 32c, and an event delivery interface 32d, and notifies a personal computer 20 that is a web client, of the occurrence of an event, and delivers the information relating to the desired event requested by the personal computer 20 through a network 100. Here the personal computer 20 is a terminal.

The HTTP server 32a is connected with the waveform measurement section 31 and the HTTP interface 32b. The HTTP interface 32b always opens the entrance (for instance, the TCP port number “80”) which is predetermined by HTTP (the first protocol) that is the communication protocol, and communicates with the personal computer 20. Furthermore, the HTTP server 32a and HTTP interface 32b are the first connection devices.

The event delivery system 32c monitors the event occurrence in the waveform measurement section 31. Also, when the HTTP server 32a receives a request of the event delivery service from personal computer 20, the event delivery system 32c dynamically generates an event delivery interface 32d. The event delivery interface 32d opens the event delivery entrance to notify the occurrence of the desired event, and carries out communication with the personal computer 20 using a unique protocol different from HTTP (the second protocol). Here, the event delivery system 32c and the event delivery interface 32d are the second connection devices.

Both of the HTTP protocol and the unique protocol are the communication 20 protocols and are application layer protocols, and layers therebelow carry out communication using the communication protocol TCP/IP (Transmission Control Protocol/Internet Protocol).

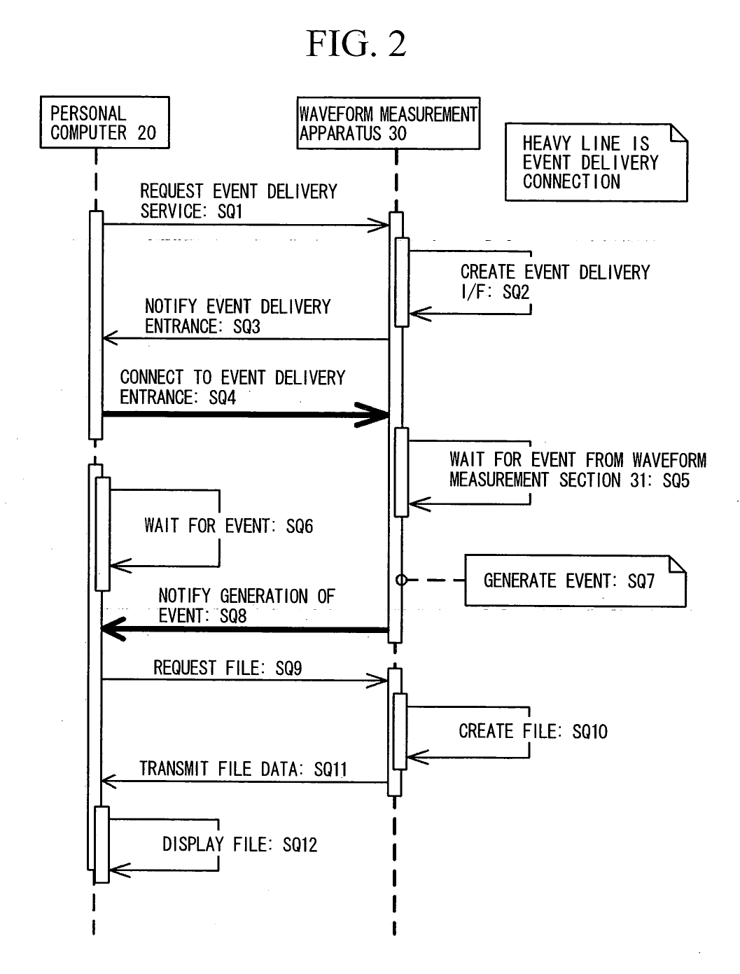

The operation of this kind of device is described referring FIG. 2. FIG. 2 is a sequence diagram that shows processing in the measurement system shown in FIG. 1. As an example, the trigger (the timing of measuring) is generated as an event in the waveform measurement section 31 of the waveform measurement apparatus 30, and the browser 21 on the personal computer 20 displays the waveform image of the measurement data gathered before and after the trigger.

First of all, the user specifies the URL (Uniform Resource Locator) address of the waveform measurement apparatus 30 on the browser 21 of the personal computer 20. Then, according to the request of the browser, the HTTP server 32a of the Web server 32 reads the program (for instance, the mark up language, HTML (Hyper Text Markup Language), the interpreter language, JAVA (Registered Trademark), or script languages, VBScript, Java Script, Active X and so forth) stored in the storage device of the waveform measurement section 31. Then the HTTP interface 32b transmits the program read by the HTTP server 32a to the personal computer 20 through the network 100.

In addition, the browser 21 of the personal computer 20 stores the program sent from the waveform measurement apparatus 30 in a memory (not shown in the drawing). Then this program is executed on the browser 21 and the window is displayed. For instance, a GUI (Graphical User Interface) is displayed using HTML. In this manner, the browser 21 connects to the predetermined interface on the HTTP interface 32 using HTTP which is the first protocol, and the HTTP connection between the personal computer 20 and waveform measurement apparatus 30 (the first connection) is established.

Next, for example, the user pushes an “Event delivery” button on the screen displayed by the browser 21. Furthermore, in addition to the trigger, the completion of a specified number of acquisitions, the occurrence of an alarm, and the occurrence of a rejection under certain conditions in the acceptance or rejection (GoNogo) test of measured waveforms may be included as events. The user has only to set the event from among these events beforehand.

Then, by the button being pushed, the browser 21 begins the request of the event delivery service from the waveform measurement apparatus 30. First of all, the browser 21 requests the notification of the occurrence of the desired event (in this case, the trigger event) by the HTTP connection (SQ1).

Meanwhile, when the event delivery service is requested from the HTTP server 32a by the personal computer 20, the event delivery system 32c of the waveform measurement apparatus 30 creates an event delivery interface 32d especially in order to notify the occurrence of the trigger event. For example, the event delivery entrance for connecting the browser 21 to the event delivery interface 32d is configured with a socket. Of course, since the socket is a TCP/IP API (Application Program Interface) it is an IP address+TCP port, but the port number of the TCP port is different from the port number of the HTTP connection (SQ2).

In addition, the HTTP interface 32b notifies the browser 21 of this event delivery entrance using the HTTP connection (SQ3).

Then the browser 21 of the personal computer 20 connects, by the unique protocol, to the event delivery entrance of the event delivery interface 32d notified by the waveform measurement apparatus 30, and the second connection is established. The second connection is hereafter referred to as an event delivery connection. Moreover, the event delivery connection is carried out by the program that is transmitted from the waveform measurement apparatus 30 to the personal computer 20 when the HTTP connection is established. More specifically, it is made to coordinate a Socket API of Java or ActiveX, GUI and components of Java and ActiveX by using, for example, VBScript (SQ4).

On the other hand, the event delivery system 32c waits for the trigger to be generated in the waveform measurement section 31 (SQ5). Similarly, the browser 21 of the personal computer 20 waits for notification of the event generation from the waveform measurement apparatus 30 (SQ6).

Then, when the trigger is generated (that is, the event is generated) in the waveform measurement section 31, the waveform measurement device stores the measurement data in the acquisition memory, and the CPU generates a picture image and carries out waveform analysis and the like (SQ7).

Furthermore, the event delivery system 32 causes the event delivery interface 32d to notify the browser 21 of the generation of the trigger event by the event delivery connection (SQ8).

With this notification as a trigger, the browser 21 requests the delivery of, for example, a picture image file from the HTTP server 32a by the HTTP connection, as information relating to the trigger event (SQ9).

On the other hand, the HTTP server 32a acquires the latest picture image from the waveform measurement section 31, and creates a picture image file that the browser 21 can display (SQ10). Then, the HTTP interface 32b is caused to transmit the picture image file data to the personal computer 20 via the HTTP connection, attaching an appropriate header (SQ11).

Then, the browser 21 of the personal computer 20 receives the picture image file data, and displays the picture image on the browser 21 (SQ12). After display, the system waits for the occurrence of an event until a trigger event occurs (SQ5, SQ6), and after the occurrence of the event (SQ7), carries out steps SQ8 to SQ12.

Thus, when it receives a request for event delivery service from the personal computer 20, the event delivery system 32c dynamically creates the event delivery interface 32d, and the occurrence of an event is notified to the personal computer 20 by the event delivery connection, which is separate from the HTTP connection. As a result, the personal computer 20 can request the picture image file in real time, synchronizing with the trigger of the waveform measurement section 31. Therefore, the image displayed on the personal computer 20 is updated in real time, synchronizing with the trigger. Moreover, since the event delivery entrance is first established only after the event delivery service is requested from the personal computer 20 (in other words, it is not always open), it is not likely to be subject to unauthorized access by a third party. Therefore, the waveform measurement apparatus 30 can carry out the delivery of information in real time and can control unauthorized access.

Moreover, since the web server 32 communicates with the personal computer 20 only when a trigger event occurs in the waveform measurement section 31, communication traffic can be controlled.

In addition, since the event delivery connection between the event delivery system 32c and the personal computer 20 is connected from the personal computer side, even in the case in which the waveform measurement apparatus 30 is on a separate network (that is, in the case where it is communicating via a router), only a simple router setting that opens the event delivery entrance of the event delivery interface to the public need be carried out.

Furthermore the present invention is not limited to this, and an example such as follows may be employed.

The construction is shown where a picture image file is sent to a personal computer 20. However the file type may be not a picture image file, but anything such as measurement data, or an alarm signal.

Also, the construction is shown where a waveform measurement apparatus 30 is used as a server apparatus. However, another measurement device may be used, for example an electric power measurement device, a voltage measurement device, a temperature measurement device and so forth. In addition, the server apparatus may be not a measurement device but, for example an information delivery device which delivers information such as stock price information. A sudden change in stock prices could constitute an event in this case. In this way the server apparatus may be any information delivery device that delivers information requested by the user of the personal computer 20 as a delivery in real time.

In addition, the construction is shown where the web server 32 is provided within the same apparatus as the waveform measurement section 31. However they may be provided separately.

1. A server apparatus that delivers information corresponding to a desired event through a network in accordance with a request from a terminal executing a client program, comprising:
first connection device that establishes first connection with said terminal applying first protocol at a predetermined entrance, and delivers a program that is executed on the client program of the terminal, and the information, to said terminal; and
second connection device that creates a new entrance when delivery of the information is requested via the first connection, and establishes second connection applying second protocol with said terminal at the new entrance, and notifies generation of the desired event; and
wherein the first connection device notifies the terminal via the first connection, of the new entrance created by the second connection device.

2. A server apparatus according to claim 1, wherein said client program is a browser.

3. A server apparatus according to claim 1, wherein the first connection and the second connection communicate applying the communication protocol TCP/IP.

4. A server apparatus according to claim 3, wherein the first protocol is HTTP, and the second protocol is a protocol different from HTTP.

5. A server apparatus according to claim 1, wherein the server apparatus is a measurement device.

6. An information delivery method in which a server apparatus delivers information corresponding to a desired event through a network to a terminal that a client program is executed, comprising:
a step in which said terminal connects to a predetermined entrance on the server applying first protocol, downloads a program that is executed on the client program and establishes first connection, and requests notification of creation of the desired event to said server apparatus;
a step in which the server apparatus creates an event delivery entrance for notifying the creation of the desired event;
a step in which the server apparatus notifies the terminal of the event delivery entrance which is created via first connection;
a step in which the terminal connects to the event delivery entrance notified by the server apparatus via second protocol and establishes second connection;
a step in which, when the event which is requested from the terminal is created, the server apparatus notifies the terminal of creation of the event via the second connection;
a step in which the terminal, on being notified of the creation of the event from the server apparatus, requests delivery of information corresponding to the event to the server via the first connection; and
a step in which the server apparatus delivers information corresponding to the event to the terminal via the first connection.
